(19) United States
(12) Patent Application Publication
(10) Pub. No.: US 2008/0256312 A1
(43) Pub. Date: Oct. 16, 2008

(54) APPARATUS AND METHOD TO DETECT AND REPAIR A BROKEN DATASET

(75) Inventors: Douglas Lee Lehr, Tucson, AZ (US); Franklin Emmert McCune, Tucson, AZ (US); David Charles Reed, Tucson, AZ (US); Max Douglas Smith, Tucson, AZ (US)

Correspondence Address: DALE F. REGELMAN;QUARLES & BRADY, LLP, ONE SOUTH CHURCH AVENUE, STE. 1700, TUCSON, AZ, 85701-1621, US

(73) Assignee: INTERNATIONAL BUSINESS MACHINES CORPORATION, Armonk, NY (US)

(21) Appl. No.: 11/734,727

(22) Filed: Apr. 12, 2007

(51) Int. Cl. G06F 12/16

(52) U.S. Cl. 711/162

(57) ABSTRACT

A method is disclosed to detect and repair a broken dataset. The method creates and maintains a backup log and an update log for a dataset. If the method finds a dataset structural error, then the method deletes the corrupted dataset, obtains the most current backup copy of the dataset, obtains all dataset updates made after the most current backup copy of the dataset was saved, and generates a recovered dataset using the most current backup and the dataset updates.

### FIELD OF THE INVENTION

This invention relates to an apparatus and method to detect and repair a broken dataset.

### BACKGROUND OF THE INVENTION

Computing systems comprise applications that utilize and/or generate information in the form of datasets. It is known in the art to save backup copies of such datasets. In today's data protection environment, more is required than simply copying a disk image to assure dataset integrity. As datasets are corrupted or broken, real time image copies simply replicate broken data.

Periodic backups are required to enable recovery when a dataset is damaged. Using prior art manual methods, the dataset recovery process can take significant time and user intervention. Using such prior art recovery methods can be costly because, among other things, the application using the dataset is not operable during the recovery process.

### SUMMARY OF THE INVENTION

Applicants' invention comprises an automated method to detect and repair a broken dataset. The automated method creates and maintains a backup log and an update log for a dataset. If the method finds a dataset structural error, then the method deletes the corrupted dataset, obtains the most current backup copy of the dataset, obtains all dataset updates made after that most current backup copy, and recovers the dataset using the most current backup copy and the dataset updates.

### BRIEF DESCRIPTION OF THE DRAWINGS

The invention will be better understood from a reading of the following detailed description taken in conjunction with the drawings in which like reference designators are used to designate like elements, and in which:

FIG. 1 is a block diagram showing one embodiment of Applicants' computing system;

FIG. 2 is a flow chart summarizing the initial steps of Applicants' method;

FIG. 3 is a flow chart summarizing additional steps of Applicants' method; and

FIG. 4 is a flow chart summarizing additional steps of Applicants' method.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

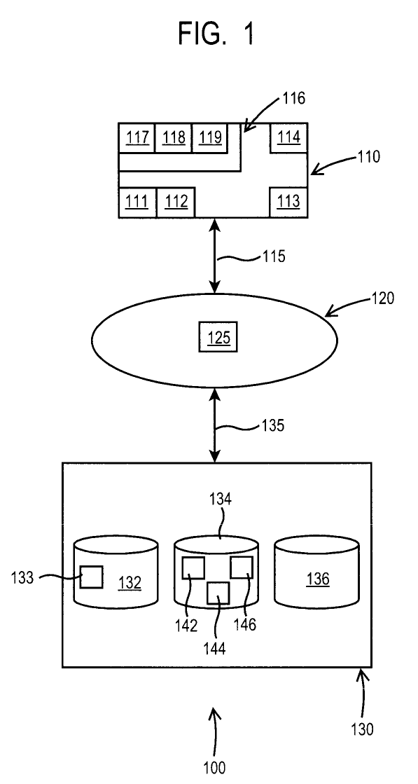

In the illustrated embodiment of FIG. 1, computing device 110 is connected to fabric 120 utilizing I/O interface 115. In certain embodiments, I/O interface 115 may comprise any type of I/O interface, for example, ESCON, FICON, Fibre Channel, Gigabit Ethernet, Ethernet, TCP/IP, iSCSI, SCSI I/O interface, and the like. In certain embodiments, computing device 110 communicates with data storage library 130 via a Simplified Network Management Protocol.

In certain embodiments, fabric 120 includes, for example, one or more switches 125. In certain embodiments, those one or more switches 125 comprise one or more conventional router switches. In the illustrated embodiment of FIG. 1, one or more switches 125 interconnect computing device 110 to management data storage library 130 via I/O protocol 135. I/O protocol 135 may comprise any type of I/O interface, for example, ESCON, FICON, Fibre Channel, Gigabit Ethernet, Ethernet, TCP/IP, iSCSI, SCSI I/O interface, or one or more signal lines used by switch 125 to transfer information through to and from library 130, and subsequently information storage media 132, 134, and 136.

As a general matter, computing device 110 is selected from the group consisting of a mainframe computer, personal computer, workstation, and combinations thereof. Computing device 110 comprises an operating system 112 such as Windows, AIX, Unix, MVS, LINUX, etc. (Windows is a registered trademark of Microsoft Corporation; AIX is a registered trademark and MVS is a trademark of IBM Corporation; UNIX is a registered trademark in the United States and other countries licensed exclusively through The Open Group; and LINUX is a registered trademark of Linus Torvald). In certain embodiments, computing device 110 further comprises a storage management program 114. In certain embodiments, that storage management program 114 may include the functionality of storage management type programs known in the art that manage the transfer of data to and from a data storage and retrieval system, such as for example and without limitation the IBM DFSMS implemented in the IBM MVS operating system.

In the illustrated embodiment of FIG. 1, computing device 110 further comprises application 113. In certain embodiments, computing device 110 further comprises memory 116. In the illustrated embodiment of FIG. 1, computing device 110 further comprises dataset 117 written to memory 116, update log 118 written to memory 116, and backup log 119 written to memory 116. In certain embodiments, application 113 is written to memory 116.

In certain embodiments, memory 116 comprises nonvolatile memory. In certain embodiments, memory 116 comprises one or more magnetic data storage media as defined herein. In certain embodiments, memory 116 comprises one or more optical data storage media as defined herein. In certain embodiments, memory 116 comprises one or more electronic data storage media as defined herein.

In the illustrated embodiment of FIG. 1, computing device communicates with storage library via fabric 120. In other embodiments, computing device 110 communicates directly with storage library 130 using I/O protocol 115.

For the sake of clarity FIG. 1 shows data storage library 130 comprising three information storage media. By “data storage medium,” Applicants mean the hardware, firmware, and/or software required to write information to, and/or read information from, a data storage medium. In certain embodiments, one or more of data storage media comprise a magnetic data storage medium, such as and without limitation a magnetic disk, magnetic tape, and the like. In certain embodiments, one or more of data storage media 132, 134, and/or 136 comprises an optical data storage medium, such as and without limitation a CD, DVD, and the like. In certain embodiments, one or more of data storage media 132, 134, and/or 136, comprises an electronic storage medium.

In other embodiments, Applicants' data storage library 130 comprises more than three information storage media. In other embodiments, Applicants' data storage library 130 comprises fewer than three information storage media.

Applicants' invention comprises a method to detect and repair a broken dataset. In certain embodiments, the method comprises five stages, including: (1) Detection which comprises steps 210 through 410, (2) Diagnostics which comprises steps 420 and 430, (3) Restore which comprises steps 440, 450, and 460, (4) Forward recover which comprises step 470, and (5) Resume which comprises step 480.

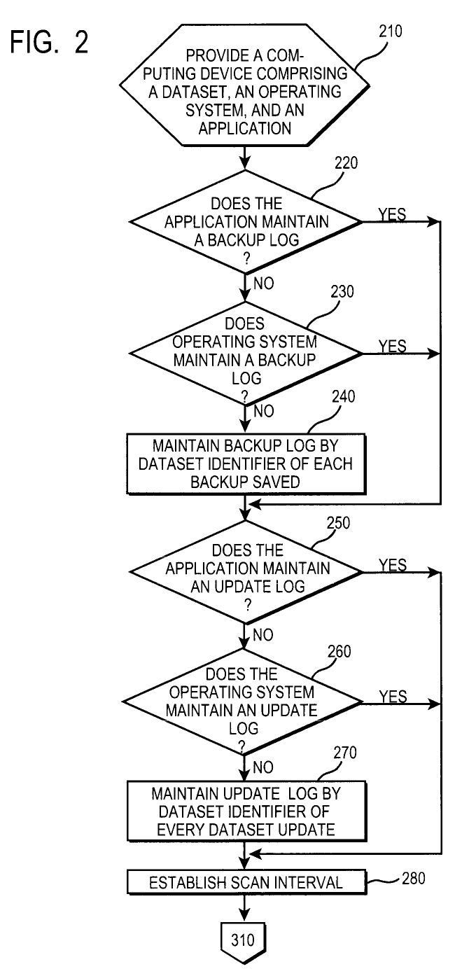

FIG. 2 summarizes the initial steps of Applicants' method. Referring now to FIG. 2, in step 210 Applicants' method supplies a computing device, such as computing device 110 (FIG. 1), comprising an application, such as application 113 (FIG. 1), an operating system, such as operating system 112 (FIG. 1), and memory, such as memory 116 (FIG. 1). In certain embodiments, the computing device of step 210 is in communication with a data storage medium, such as data storage medium 132 (FIG. 1). The method in step 210 further supplies a dataset, such as dataset 117 (FIG. 1), created by and/or used by the application.

In step 220, the method determines if the application establishes a backup interval and maintains a backup log for the dataset, wherein the backup interval comprises a designated time interval after which a dataset backup is saved to the data storage medium, and wherein the backup log comprises the backup date and backup address where the most recent dataset backup is saved. In certain embodiments, such a dataset backup is saved in memory 116 (FIG. 1). In certain embodiments, such as dataset backup is saved in a data storage medium, such as data storage medium 132 (FIG. 1). In certain embodiments, step 220 is performed by a processor disposed in the computing device. In certain embodiments, step 220 is performed by a storage management program disposed in the computing device.

If the method determines in step 220 that the application establishes a backup interval and maintains a backup log for the dataset, then the method transitions from step 220 to step 250. Alternatively, if the method determines in step 220 that the application does not establish a backup interval and maintain a backup log for the dataset, then the method transitions from step 220 to step 230 wherein the method determines if the operating system establishes a backup interval and maintains a backup log for the dataset. In certain embodiments, step 230 is performed by a processor disposed in the computing device. In certain embodiments, step 230 is performed by a storage management program disposed in the computing device.

If the method determines in step 230 that the operating system establishes a backup interval and maintains a backup log for the dataset, then the method transitions from step 230 to step 250. Alternatively, if the method determines in step 230 that the operating system does not establish a backup interval and maintain a backup log for the dataset, then the method transitions from step 230 to step 240 wherein the method establishes a backup interval for the dataset and wherein the method establishes and maintains a backup log, such as backup log 118 (FIG. 1) for the dataset. In certain embodiments, step 240 is performed by a processor disposed in the computing device. In certain embodiments, step 240 is performed by a storage management program disposed in the computing device.

The method transitions from step 240 to step 250 wherein the method determines if the application establishes and maintains an update log for the dataset and saves each update until the next dataset backup is saved. In certain embodiments, step 250 is performed by a processor disposed in the computing device. In certain embodiments, step 250 is performed by a storage management program disposed in the computing device.

If the method determines in step 250 that the application establishes and maintains an update log for the dataset and saves each update until the next dataset backup is saved, then the method transitions from step 250 to step 280. Alternatively, if the method determines in step 250 that the application does not establish and maintain an update log for the dataset and save each update until the next dataset backup is saved, then the method transitions from step 250 to step 260 wherein the method determines if the operating system establishes and maintains an update log for the dataset and saves each update until the next dataset backup is saved. In certain embodiments, step 230 is performed by a processor disposed in the computing device. In certain embodiments, step 260 is performed by a storage management program disposed in the computing device.

If the method determines in step 260 that the operating system establishes and maintains an update log for the dataset and saves each update until the next dataset backup is saved, then the method transitions from step 260 to step 280. Alternatively, if the method determines in step 260 that the operating system does not establishes and maintains an update log for the dataset and saves each update until the next dataset backup is saved, then the method transitions from step 260 to step 270 wherein the method establishes and maintains an update log, such as update log 119 (FIG. 1), for the dataset and saves each update, such as updates 142 (FIG. 1), 144 (FIG. 1), and 146 (FIG. 1), until the next dataset backup is saved. In certain embodiments, step 270 is performed by a processor disposed in the computing device. In certain embodiments, step 270 is performed by a storage management program disposed in the computing device.

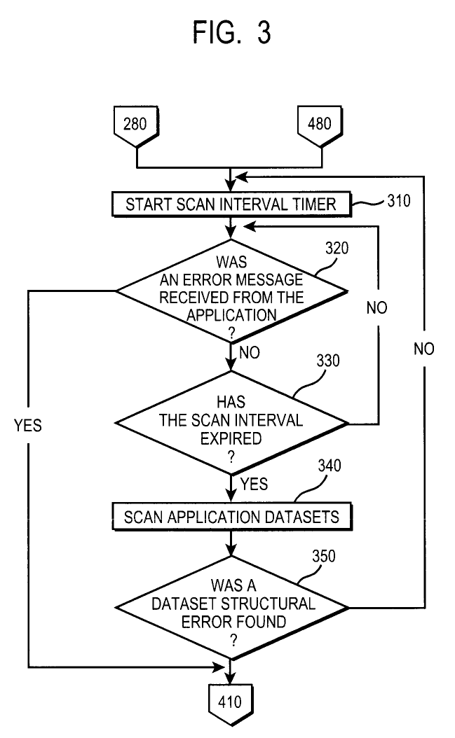

The method transitions from step 270 to step 280 wherein the method establishes a scan interval, wherein at the expiration of the scan interval the method scans each dataset to determine if any dataset comprise one or more structural errors. The method transitions from step 280 to step 310 (FIG. 3).

In certain embodiments, step 280 is performed by the owner of each dataset generated and/or used by the computing device. In certain embodiments, step 280 is performed by the owner of the computing device. In certain embodiments, step 280 is performed by a processor disposed in the computing device. In certain embodiments, step 280 is performed by a storage management program disposed in the computing device.

Referring now to FIG. 3, in step 310 the method starts the scan interval timer. In certain embodiments, step 310 is performed by a processor disposed in the computing device. In certain embodiments, step 310 is performed by a storage management program disposed in the computing device.

In step 320, the method determines if an error message was received from the application. In certain embodiments, step 320 is performed by a processor disposed in the computing device. In certain embodiments, step 320 is performed by a storage management program disposed in the computing device.

Receipt of such an application error message indicates a non-structural error in the dataset being generated and/or used by the application. As an example and without limitation, if the application expects to use a dataset comprising a 4 kilobyte data block, but instead finds a 6 kilobyte data block, then the application returns an error message. Such a 6 kilobyte data block could result from, for example and without limitation, a first data block partially overwriting a second data block thereby generating corrupted data.

If the method determines in step 320 that an error message was received from the application, then the method transitions from step 320 to step 410. Alternatively, if the method determines in step 320 that an error message has not been received from the application, then the method transitions from step 320 to step 330 wherein the determines if the scan interval has expired. In certain embodiments, step 330 is performed by a processor disposed in the computing device. In certain embodiments, step 330 is performed by a storage management program disposed in the computing device.

If the method determines in step 330 that the scan interval has not expired, then the method transitions from step 330 to step 320 and continues as described herein. Alternatively, if the method determines in step 320 that the scan interval timer has expired then the method transitions from step 330 to step 340 wherein the method scans each application dataset to determine if any of those datasets comprises a structural error. In certain embodiments, step 340 is performed by a processor disposed in the computing device. In certain embodiments, step 340 is performed by a storage management program disposed in the computing device.

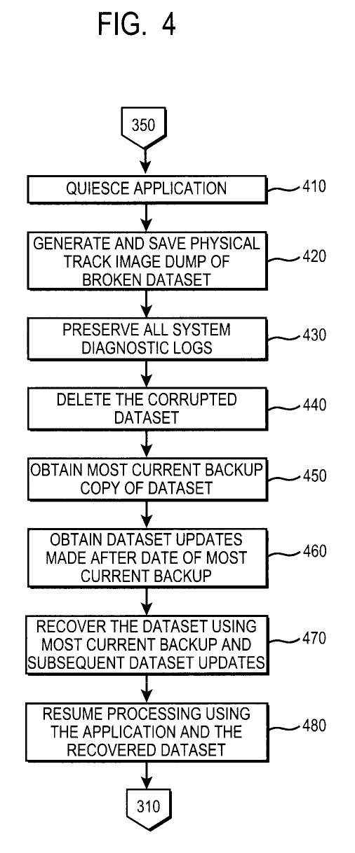

In step 350, the method determines if a dataset structural error was found in step 340. In certain embodiments, step 350 is performed by a processor disposed in the computing device. In certain embodiments, step 350 is performed by a storage management program disposed in the computing device. If the method determines in step 350 that a dataset structural error was not found in step 340, then the method transitions from step 350 to step 310 and continues as described herein. Alternatively, if the method determines in step 350 that a dataset structural error was found in step 340, then the method transitions from step 350 to step 410 (FIG. 4).

Referring now to FIG. 4, in step 410 the method quiesces the application. In certain embodiments, step 410 is performed by a processor disposed in the computing device. In certain embodiments, step 410 is performed by a storage management program disposed in the computing device.

In step 420, the method generates and saves a physical track image of the corrupted dataset. In certain embodiments, step 420 is performed by a processor disposed in the computing device. In certain embodiments, step 420 is performed by a storage management program disposed in the computing device.

In step 430, the method preserves all system diagnostic logs. In certain embodiments, step 430 is performed by a processor disposed in the computing device. In certain embodiments, step 430 is performed by a storage management program disposed in the computing device.

In step 440, the method deletes the corrupted dataset. In certain embodiments, step 440 is performed by a processor disposed in the computing device. In certain embodiments, step 440 is performed by a storage management program disposed in the computing device.

In step 450, the method retrieves the most current backup copy of the dataset. In certain embodiments, step 450 comprises using the backup log of step 240 (FIG. 2) to locate the most current backup copy of the dataset. In certain embodiments, step 450 comprises invoking one or more error recovery procedures encoded in the application to retrieve the most current backup copy of the dataset In certain embodiments, step 450 is performed by a processor disposed in the computing device. In certain embodiments, step 450 is performed by a storage management program disposed in the computing device.

In step 460, the method retrieves all dataset updates made after the most current dataset backup was saved. In certain embodiments, step 460 comprises using the updates log of step 270 (FIG. 2). In certain embodiments, step 450 comprises invoking one or more error recovery procedures encoded in the application to retrieve all dataset updates made after the most current dataset backup was saved. In certain embodiments, step 460 is performed by a processor disposed in the computing device. In certain embodiments, step 460 is performed by a storage management program disposed in the computing device.

In step 470, the method recovers the corrupted dataset using the retrieved most current backup copy of step 450 and the retrieved dataset updates of step 460. In certain embodiments, step 450 comprises invoking one or more error recovery procedures encoded in the application to recover the corrupted dataset using the retrieved most current backup copy of step 450 and the retrieved dataset updates of step 460. In certain embodiments, step 470 is performed by a processor disposed in the computing device. In certain embodiments, step 470 is performed by a storage management program disposed in the computing device.

In step 480, the method resumes processing using the application and the recovered dataset of step 470. Applicants' method transitions from step 480 to step 310 and continues as described herein.

Applicants' invention can be used by a data storage services provider when providing data storage services to one or more data storage services customers. For example, in certain embodiments a data storage services customer owns and/or operates computing device 110 (FIG. 1), and a data storage services provider owns and/or operates storage library 130 (FIG. 1), wherein a dataset 133 (FIG. 1) comprising a backup copy of dataset 117 (FIG. 1) is saved.

In certain embodiments, individual steps recited in FIG. 2 and/or FIG. 3 and/or FIG. 4, may be combined, eliminated, or reordered.

In certain embodiments, Applicants' invention includes instructions residing in computer readable medium, such as for example memory 116 (FIG. 1), wherein those instructions are executed by a processor, such as processor 111 (FIG. 1) to perform one or more of steps 220, 230, 240, 250, 260, 270, and/or 280, recited in FIG. 2, and/or one or more of steps 310, 320, 330, 340, and/or 350, recited in FIG. 3, and/or one or more of steps 410, 420, 430, 440, 450, 460, 470, and/or 480, recited in FIG. 4.

In other embodiments, Applicants' invention includes instructions residing in any other computer program product, where those instructions are executed by a computer external to, or internal to, system 100, to perform one or more of steps 220, 230, 240, 250, 260, 270, and/or 280, recited in FIG. 2, and/or one or more of steps 310, 320, 330, 340, and/or 350, recited in FIG. 3, and/or one or more of steps 410, 420, 430, 440, 450, 460, 470, and/or 480, recited in FIG. 4. In either case, the instructions may be encoded in an information storage medium comprising, for example, a magnetic information storage medium, an optical information storage medium, an electronic information storage medium, and the like. By “electronic storage media,” Applicants mean, for example and without limitation, one or more devices, such as and without limitation, a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

We claim:

1. A method to detect and repair a broken dataset, comprising the steps of:
providing a computing device comprising an operating system, an application and a dataset used by said application;
determining if said application maintains a backup log for said dataset;
operative if said application does not maintain a backup log for said dataset, determining if said operating system maintains a backup log for said dataset;
operative if said operating system does not maintain a backup log for said dataset, creating and maintaining a backup log for said dataset.

2. The method of claim 1, further comprising the steps of:
determining if said application maintains an update log for said dataset;
operative if said application does not maintain an update log for said dataset, determining if said operating system maintains an update log for said dataset;
operative if said operating system does not maintain an update log for said dataset, creating and maintaining an update log for said dataset.

3. The method of claim 2, further comprising the steps of:
establishing a scan interval;
providing a scan interval timer;
starting said scan interval timer;
ascertaining if said scan interval has expired;
operative if said scan interval has expired, scanning said dataset to detect a dataset structural error.

4. The method of claim 3, further comprising the steps of:
operative of a dataset structural error was not detected, saving a backup copy of said dataset;
ascertaining if said application generated an error message;
operative if said application did not generate an error message, repeating said starting step, said scanning step, said saving step, said ascertaining steps, and said repeating step.

5. The method of claim 3, further comprising the steps of:
operative if a dataset structural error was detected or if said application generated an error message, quiescing said application;
generating and saving a physical track image dump of the corrupted dataset comprising a structural error;
preserving all system diagnostic logs;
deleting the corrupted dataset.

6. The method of claim 5, further comprising the steps of:
obtaining the most current backup copy of the corrupted dataset;
obtaining all dataset updates made after the most current backup copy of the dataset was saved;
generating a recovered dataset using said most current backup and said dataset updates;
resuming said application using said recovered dataset.

7. A article of manufacture comprising an operating system, an application, a dataset used by said application, and a computer readable medium having computer readable program code disposed therein to detect and repair a broken dataset, the computer readable program code comprising a series of computer readable program steps to effect:
determining if said application maintains a backup log for said dataset;
operative if said application does not maintain a backup log for said dataset, determining if said operating system maintains a backup log for said dataset;
operative if said operating system does not maintain a backup log for said dataset, creating and maintaining a backup log for said dataset.

8. The article of manufacture of claim 7, said computer readable program code further comprising a series of computer readable program steps to effect:
determining if said application maintains an update log for said dataset;
operative if said application does not maintain an update log for said dataset, determining if said operating system maintains an update log for said dataset;
operative if said operating system does not maintain an update log for said dataset, creating and maintaining an update log for said dataset.

9. The article of manufacture of claim 8, wherein said article of manufacture further comprises a scan interval timer, said computer readable program code further comprising a series of computer readable program steps to effect:
retrieving a pre-determined scan interval;
starting said scan interval timer;
ascertaining if said scan interval has expired;
operative if said scan interval has expired, scanning said dataset to detect a dataset structural error.

10. The article of manufacture of claim 9, said computer readable program code further comprising a series of computer readable program steps to effect:
operative if a dataset structural error was detected or if said application generated an error message, quiescing said application;
generating and saving a physical track image dump of the corrupted dataset comprising a structural error;
preserving all system diagnostic logs;
deleting the corrupted dataset.

11. The article of manufacture of claim 10, further comprising the steps of:
obtaining the most current backup copy of the corrupted dataset;
obtaining all dataset updates made after the most current backup copy of the dataset was saved;
generating a recovered dataset using said most current backup and said dataset updates;
resuming said application using said recovered dataset.

12. A computer program product encoded in an information storage medium disposed in a computing device, wherein said computer program product is usable with a programmable computer processor to detect and repair a broken dataset, comprising:
computer readable program code which causes said programmable computer processor to determine if said application maintains a backup log for said dataset;
computer readable program code which, if said application does not maintain a backup log for said dataset, causes said programmable computer processor to determine if said operating system maintains a backup log for said dataset;
computer readable program code which, if said operating system does not maintain a backup log for said dataset, causes said programmable computer processor to create and maintain a backup log for said dataset.

13. The computer program product of claim 12, further comprising:
computer readable program code which causes said programmable computer processor to determine if said application maintains an update log for said dataset;
computer readable program code which, if said application does not maintain an update log for said dataset, causes said programmable computer processor to determine if said operating system maintains an update log for said dataset;
computer readable program code which, if said operating system does not maintain an update log for said dataset, causes said programmable computer processor to create and maintain an update log for said dataset.

14. The computer program product of claim 13, wherein said computing device further comprises a scan interval timer, further comprising:
computer readable program code which causes said programmable computer processor to retrieve a pre-determined scan interval;
computer readable program code which causes said programmable computer processor to start said scan interval timer;
computer readable program code which causes said programmable computer processor to ascertain if said scan interval has expired;
computer readable program code which, if said scan interval has expired, causes said programmable computer processor to scan said dataset to detect a dataset structural error.

15. The computer program product of claim 14, further comprising:
computer readable program code which, if a dataset structural error was detected or if said application generated an error message, causes said programmable computer processor to quiesce said application;
computer readable program code which causes said programmable computer processor to generate and save a physical track image dump of the corrupted dataset comprising a structural error;
computer readable program code which causes said programmable computer processor to preserve all system diagnostic logs;
computer readable program code which causes said programmable computer processor to delete the corrupted dataset.

16. The computer program product of claim 15, further comprising:
computer readable program code which causes said programmable computer processor to obtain the most current backup copy of the dataset;
computer readable program code which causes said programmable computer processor to obtain all dataset updates made after the most current backup copy of the dataset was saved;
computer readable program code which causes said programmable computer processor to generate a recovered dataset using said most current backup and said dataset updates;
computer readable program code which causes said programmable computer processor to resume said application using said recovered dataset.

17. A method provide data storage services to a data storage services customer, comprising the steps of:
receiving a dataset from a customer, wherein said dataset is used by a customer application running on a customer computing device;
saving said dataset in one or more information storage media;
creating and maintaining a backup log for said dataset.
creating and maintaining an update log for said dataset.

18. The method of claim 17, further comprising the steps of:
establishing a scan interval;
providing a scan interval timer;
starting said scan interval timer;
ascertaining if said scan interval has expired;
operative if said scan interval has expired, scanning said dataset to detect a dataset structural error.

19. The method of claim 18, further comprising the steps of:
operative if a dataset structural error was detected, generating and saving a physical track image dump of the corrupted dataset comprising a structural error;
deleting the corrupted dataset.

20. The method of claim 19, further comprising the steps of:
obtaining the most current backup copy of the corrupted dataset;
obtaining all dataset updates made after the most current backup copy of the dataset was saved;
generating a recovered dataset using said most current backup and said dataset updates.
